(19) United States
(12) Patent Application Publication
(10) Pub. No.: US 2024/0174493 A1
(43) Pub. Date: May 30, 2024

(54) SUPPORT AND TRANSPORTATION PLATFORM FOR INDUSTRIAL VALVES

(71) Applicant: Saudi Arabian Oil Company, Dhahran (SA)

(72) Inventors: Ali A. Aliwi, Al-Mubarraz (SA); Allaa M. Binabd, Al-Ahsa (SA); Mohammad A. Almosa, Al-Ahsa (SA); Ridha A. Alhassan, Al-Ahsa (SA); Yazeed S. Alsalamah, Al-Ahsa (SA)

(21) Appl. No.: 17/994,695

(22) Filed: Nov. 28, 2022

(51) Int. Cl. B66C 1/22; F16M 11/22

(52) U.S. Cl. CPC B66C 1/22; F16M 11/22; F16M 2200/08

(57) ABSTRACT

A support and transportation platform for industrial valves includes a base plate and multiple holding attachments. The base plate has a surface area that is greater than a surface area of an industrial tool to be supported and transported by the assembly. The base plate has a first surface and a second surface opposite the first surface. Each holding attachment includes a first beam and a second beam attached to each other to form an L-shape. Each first beam can be removably attached to the first surface of the base plate. Each second beam can extend perpendicularly away from the first surface. Each first beam defines a respective slot through which a respective holding attachment can be removably attached to the base plate. Each second beam defines a respective slot through which the industrial tool is to be removably attached to the multiple holding attachments.

### TECHNICAL FIELD

This disclosure relates to supporting and transporting industrial tools, for example, industrial valves.

### BACKGROUND

Operating facilities implement a variety of tools or industrial equipment to perform operations. For example, a facility that implements fluid flow operations implements multiple valves to perform the operations. Such valves can include block valves (e.g., gate valves, globe valves, butterfly valves) and flow directional control valves (e.g., check valves). Operating and maintaining valves or other tools or industrial equipment involves transporting the tools or industrial equipment from one location to another, e.g., within the facility itself or between the facility and another location. Properly supporting the tool or industrial equipment during such transportation is important.

### SUMMARY

This specification describes technologies relating to a support and transportation platform for industrial tools or industrial equipment, e.g., industrial valves.

Certain aspects of the subject matter described here can be implemented as an industrial tool support and transportation assembly that includes a base plate and multiple holding attachments. The base plate has a surface area that is greater than a surface area of an industrial tool to be supported and transported by the assembly. The base plate has a first surface and a second surface opposite the first surface. Each holding attachment includes a first beam and a second beam attached to each other to form an L-shape. Each first beam can be removably attached to the first surface of the base plate. Each second beam can extend perpendicularly away from the first surface. Each first beam defines a respective slot through which a respective holding attachment can be removably attached to the base plate. Each second beam defines a respective slot through which the industrial tool is to be removably attached to the multiple holding attachments.

An aspect combinable with any other aspect can include the following features. The assembly includes multiple saddle supports. Each support can be removably attached to the first surface. The multiple supports cooperate with the multiple holding attachments to prevent the industrial tool from falling when the industrial tools is disconnected from each second beam.

An aspect combinable with any other aspect can include the following features. The assembly includes multiple square tubes. A square tube is connected to two holding attachments. A length of the square tube is variable to adjust a distance between the two holding attachments to which the square tube is connected based on a dimension of the industrial tool to be supported by the multiple holding attachments.

An aspect combinable with any other aspect can include the following features. The base plate defines multiple slots. Each slot is formed adjacent to a square tube. Each slot defined by the base plate can be aligned with the respective slot defined by the first beam to removably attach the industrial tool to the base plate.

An aspect combinable with any other aspect can include the following features. A square tube is attached to the second surface of the base plate. A length of the square tube is variable to adjust a distance between ends of the square tube. The ends of the square tube can guide a forklift along the second surface of the base plate.

An aspect combinable with any other aspect can include the following features. The assembly includes multiple L-beams. Each L-beam is attached to the second surface of the base plate. the multiple L-beams can support the base plate when the assembly is placed on a floor.

An aspect combinable with any other aspect can include the following features. The base plate is a rectangular base plate. The assembly includes multiple lifting eyes. Each lifting eye is attached to a respective corner of the base plate. Each lifting eye defines a through hole to connect the multiple lifting eyes to a crane to lift the base plate.

An aspect combinable with any other aspect can include the following features. The multiple holding attachments include four holding attachments arranged on the first surface in an arrangement within which the industrial tool can be positioned.

Certain aspects of the subject matter described here can be implemented as an industrial tool support and transportation assembly. The assembly includes a base plate, four holding attachments and two saddle supports. The base plate has a first surface and a second surface opposite the first surface. The base plate defines a surface area that is greater than a surface area of an industrial tool to be supported and transported by the assembly. Each holding attachment is formed in an L-shape. Each holding attachment includes a first beam that is parallel to and removably attached to the first surface. Each second beam is perpendicular to the first surface. Each second beam is attached to a respective first beam. The four holding attachments are spatially arranged on the first surface to define an inner volume in which the industrial tool is to be received. The two saddle supports are positioned in the inner volume and attached to the first surface. The two saddle supports can cooperate with the four holding attachments to maintain the industrial tool in an upright position.

An aspect combinable with any other aspect can include the following features. Each first beam of each holding attachment defines a respective slot through which the respective holding attachment is removably attached to the base plate.

An aspect combinable with any other aspect can include the following features. The base plate defines four slots. Each slot at least partially overlaps with a respective slot defined by each first beam of each of the four holding attachments. The four slots defined by the base plate and the overlapping respective slots defined by the first beams of the four holding attachments are configured to receive respective fasteners to attach the respective holding attachment to the first surface of the base plate.

An aspect combinable with any other aspect can include the following features. The assembly includes a first square tube connecting a first beam of a first holding attachment to a first beam of a second holding attachment. The first square tube is attached to the first surface of the base plate. A length of the first square tube is variable to adjust a distance between the first holding attachment and the second holding attachment. The assembly includes a second square tube connecting a first beam of a third holding attachment to a first beam of a fourth holding attachment. The second square tube is attached to the first surface of the base plate. A length of the second square tube is variable to adjust a distance between the third holding attachment and the fourth holding attachment.

An aspect combinable with any other aspect can include the following features. The assembly includes a square tube attached to the second surface of the base plate. A length of the square tube is variable to adjust a distance between ends of the square tube. The ends of the square tube can guide a forklift along the second surface of the base plate.

An aspect combinable with any other aspect can include the following features. The assembly includes multiple L-beams. Each L-beam is attached to the second surface of the base plate. The multiple L-beams can support the base plate when the assembly is placed on a floor.

An aspect combinable with any other aspect can include the following features. The base plate is a rectangular base plate. The assembly includes multiple lifting eyes. Each lifting eye is attached to a respective corner of the base plate. Each lifting eye defines a through hole to connect the multiple lifting eyes to a crane to lift the base plate.

An aspect combinable with any other aspect can include the following features. The multiple holding attachments includes four holding attachments arranged on the first surface in an arrangement within which the industrial tool can be positioned.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an industrial tool support and transportation assembly.

FIG. 2 is an example of an industrial valve placed on the assembly of FIG. 1.

FIG. 3 is an example of the industrial valve fixed to the assembly of FIG. 1.

FIG. 4 is an example of the industrial valve removably attached to the assembly of FIG. 1.

Like reference numbers and designations in the various drawings indicate like elements.

### DETAILED DESCRIPTION

Industrial tools or industrial equipment such as industrial valves need to be easily, reliably and safely handled and transported for storage, overhauling or hydrostatic testing purposes. Transporting an industrial valve on a wooden pallet can lack safety since the valve is not fixed to one location on the pallet and consequently can move/slide on the pallet. Therefore, wooden pallets are unsuitable for transportation or hydrostatic testing purposes. Also, because pallets have fixed sizes, pallets can be used to transport valves of only certain sizes that can fit on the pallets. Pallets have a fixed valve elevation which can be challenging when pallets are used for overhauling. Some pallets cannot be transported using forklifts.

Saddle supports are another example of structures that can be used to transport industrial equipment. A saddle support is a structure that includes a base, e.g., a horizontal base, to align against a support surface, and a curved portion with a curvature that matches the curvature of the industrial tool or equipment that the saddle support supports. For example, a pair of saddle supports can be positioned at a distance apart from each other, and the curved portions of the pair of saddle supports can support a curved body of an industrial valve. While saddle supports can offer more stability than pallets, saddle supports are also limited by lack of size flexibility, fixed vertical elevation and, sometimes, inability to be transported using forklifts.

The support and transportation platform for industrial tools or equipment (e.g., for industrial valves) described in this disclosure can be used safely and reliably to store, overhaul and test (e.g., hydrostatically test) industrial valves. The platform can hold down valves horizontally in one fixed location on the platform. The platform has a flexible re-sizing mechanism (described later) that allows the platform to accommodate a wide range of valves sizes and types. As described below, the platform can horizontally accommodate any flanged valve that can be stored in a horizontal position. The platform provides a faster, easier and safer way of valves transportation by enabling the valve to be lifted with a crane, sling or forklift without touching the valve body. The components of the platform are made of a material that has sufficient strength to support the weight of the industrial valves and is also coated externally for corrosion protection. The material used to make components of the platform are cost effective, readily available in the market and compatible with materials using which the industrial tools (e.g., the valve materials) are made.

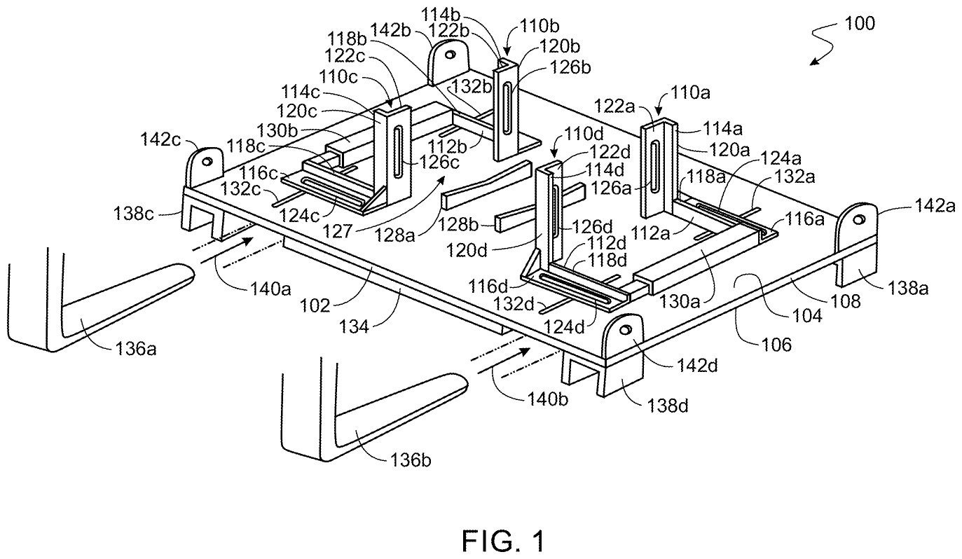

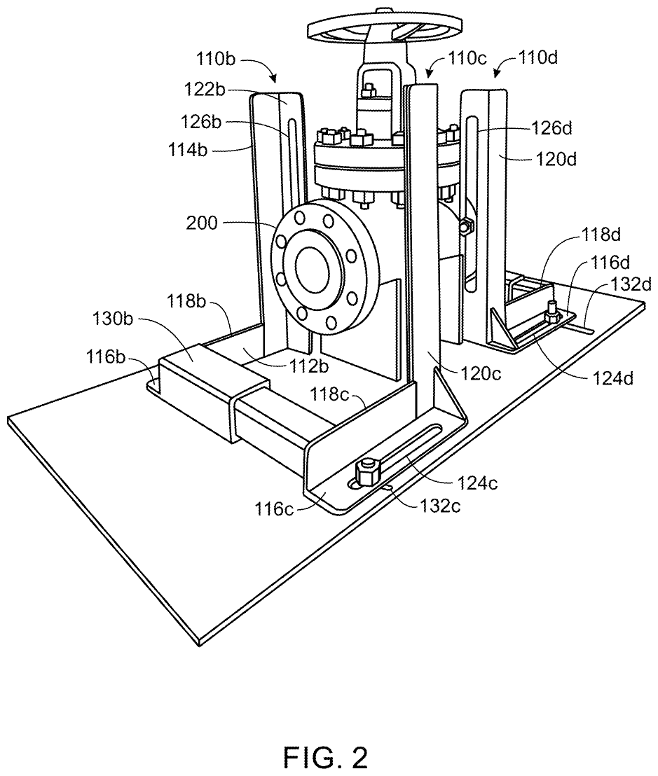

FIG. 1 is a schematic diagram of an industrial tool support and transportation assembly 100. The assembly 100 includes a base plate 102 on which the industrial tool (not shown in FIG. 1, but shown in FIGS. 2-4) rests. The base plate 102 has a surface area that is large enough to accommodate the industrial tool. For example, the surface area of the base plate 102 is greater than a foot print (e.g., surface area) of the industrial tool that the base plate 102 is meant to support. The base plate 102 additionally supports other components of the assembly 100 that are described here. In some implementations, the base plate 102 is rectangular. The base plate 102 has a first surface 104 (e.g., an upper surface) on which the industrial tool rests, a second surface 106 (e.g., a lower surface) opposite the first surface 104, and a thickness 108. The dimensions of the base plate 102 can be chosen based on the dimensions of the industrial tool. For example, the base plate 102 can be 42″ long, 20″ wide and ⅜″ thick.

The assembly 100 includes multiple holding attachments (e.g., four holding attachments)—attachments 110a, 110b, 110c, 110d. In implementations in which the industrial tool is an industrial valve, each holding attachment is a valve holder. Each holding attachment includes a first beam (e.g., first beams 112a, b, c, d for respective first attachments 110a, b, c, d) and a second beam (e.g., second beams 114a, b, c, d for respective first attachments 110a, b, c, d). Each first beam and each second beam are attached to each other (e.g., at respective ends) to form an L-shape. Each first beam can be removably attached to the first surface 104 of the base plate 102. With the first beam so attached, the connected second beam extends perpendicularly away from the first surface 104.

Each first beam can be made of two rectangular plates (e.g., plate 116d and plate 118d for first beam 112d) attached (e.g., welded) in an L-shape. For the first beam 112a, the plate 116a can lie flat on the base plate 102, and the plate 118a can extend perpendicular to the base plate 102. Each first beam can define a slot through which the respective holding attachment is removably attached to the base 102. For example, for the first holding attachment 110a includes the first beam 112a which includes the plate 116a and the plate 118a. The plate 116a, namely, the plate that lies flat on the base plate 102, defines a slot 124a through which a fastener can be passed. Similarly, plates 116b, c, d, each of which lies flat on the base plate 102, defines respective slots 124b, c, d. As described later, the fastener also passes through a slot defined by the base 102 that overlaps with the slot 124a in the plate 124a. The fastener attaches the holding attachment to the base 102 and can be loosened to remove the attachment from the base 102. The dimensions of each first beam and each second beam can be chosen based on the dimensions of the industrial tool. For example, each plate that defines a slot on each first beam can be 10″ long. The slot can be 6½″ long and ¾″ wide.

Similar to the first beam, each second beam can also be made of two rectangular plates (e.g., plate 120d and plate 122d for the second beam 114d). For the second beam 114a, the plate 120a can be attached to the plate 118a (i.e., the plate of the corresponding first beam 112a that extends perpendicular to the base 102). The plate 122a can be attached (e.g., welded) to the plate 120a in an L-shape. The plate 120a of the second beam 114a can be attached (e.g., welded) to the plate 118a of the first beam 114a. The second beam 114a can further be buttressed by a triangular plate that attaches, one one edge, to the second beam 114a and attaches, on a perpendicular edge to the base plate 102. The plates 122a, b, c, d of the second beam 114a, b, c, d define respective slots 126a, b, c, d through which the industrial tool is to be removably attached. As described later, a fastener can be passed through the slot in the second beam 114a and through the industrial tool. The fastener attaches the industrial tool to the holding attachment and can be loosened to remove the industrial tool from the holding attachment. For example, each plate that defines a slot on each second beam can be 18″ long. The slot can be 12 ½″ long and 1″ wide.

The four holding attachments—110a, 110b, 110c and 110d—are spatially arranged on the base plate 102 to define an inner volume 127 in which the industrial tool is to be received. When spatially arranged as shown in FIG. 1, the slots on second beams of two holding attachments (e.g., holding attachments 110a and 110b, and holding attachments 110c and 110d) face each other.

In some implementations, multiple saddle supports (e.g., a first saddle support 128a, a second saddle support 128b) can be removably attached to the first surface 104 of the base plate 102. For example, each saddle support can be positioned in the inner volume 127 defined by the spatially arranged holding attachments. The saddle supports work cooperatively with the holding attachments to retain the industrial tool in the inner volume 127. In particular, the saddle supports ensure that the industrial tool does not fall when the industrial tool is removed from the second beams of the holding attachments. To do so, each saddle support includes a flat base that is attachable to the first surface 104 of the base plate 102, and an angled (e.g., curved) top opposite the flat base. When the industrial tool is positioned in the inner volume 127, an outer surface of the industrial tool rests on the angled top of the saddle support.

In some implementations, multiple square tubes (e.g., a first square tube 130a, a second square tube 130b) to facilitate spatially arranging the four holding attachments to define the inner volume 127 that is large enough to fit the industrial tool. Each square tube is connected to two holding attachments. For example, the square tube 130a is connected to the holding attachment 110a and the holding attachment 110d. Specifically, one end of the square tube 130a is connected to the plate 118d of the beam 112d, and the other end of the square tube 130b is connected to the plate 118a of the beam 118a. Similarly, the ends of the square tube 130b are connected to the plates 118c and 118b, respectively. Each square tube includes pipes having a square or rectangular cross-section, one pipe telescoping within the other, which together allows varying a length of the square tube. Thus, by telescoping the pipes within each square tube, a distance between the holding attachments connected to the square tube can be varied according to the size of the industrial tool. For example, the length of the square tubes 130a, 130b can be variable between 7¼″ and 8½″.

In some implementations, the base plate 102 defines multiple slots (e.g., four slots 132a, b, c, d). Each slot is formed adjacent to a square tube. Each slot can be aligned with a respective slot defined by a first beam to removably attach the industrial tool to the base plate 102. For example, each slot can be a through hole that passes through the thickness 108 of the base plate 102. All four slots 132a, b, c, d can be oriented in the same direction, e.g., with long dimensions along the width of the base plate 102 and the short dimensions along the length of the base plate 102, or vice versa. As described above, the plates 116a, b, c, d, of the first beams 112a, b, c, d, respectively (i.e., the plates that lie flat on the base plate 102), define respective slots 124a, b, c, d. When the holding attachments are positioned on the base plate 102, the slots 124a, b, c, d can be perpendicular to the slots 132a, b, c, d. That is, a long dimension of the slot 124a and a short dimension of the slot 132a can be parallel, and a short dimension of the slot 124a and a long dimension of the slot 132a can be parallel. The first beams can be placed on the slots defined by the base plate 102 such that the slots on the plates 116a, b, c, d overlap with the slots 132a, b, c, d, respectively. A location of a holding attachment over a corresponding slot can be chosen based on the inner volume 127 to be defined by the spatial arrangement of the holding attachments on the base plate 102. For example, the length of the slot can be 6″, and the width of the slot can be ¾″. An end of each slot defined by the base plate 102 can be 2″ from the edge of the base plate 102.

In some implementations, a square tube 134 can be attached to the second surface 106, i.e., the lower surface, of the base plate 102. The square tube 134 is similar to the square tube 130a or 130b in construction. A length of the square tube 134 is variable to adjust a distance between ends of the square tube 134. Forklift arms (e.g., arms 136a, 136b) can be slid under the base plate 102 to lift the base plate 102 with/without the industrial tool. In some implementations, the length of the square tube 134 can be adjusted based on the distance between the forklift arms 136a, 136b. In this manner, the forklift arms can be centered on the second surface 106 of the base plate 102. For example, a maximum length of the square tube 134 can be 20″. When extended, each end of the square tube 134 can be 11″ from the end of the base plate 102. The square tube 134 can have dimensions of 2″×2″×¼″.

In some implementations, multiple base plate supports (e.g., four base plate supports—138a, 138b (hidden), 138c, 138d) can be attached to the second surface 106, i.e., the lower surface, of the base plate 102. The four base plate supports can be attached to the four corners on the lower surface of the base plate 102. Each base plate support can be an L-beam or a U-beam. With the four base plate supports attached to the bottom four corners of the base plate 102, the assembly 100 can be positioned on the floor, e.g., of a facility or a workshop. Each end of the square tube 134 is spaced apart from a respective base plate support such that the forklift arms 136a, 136b slide in the spaces 140a, 140b between an end of the square tube 134 and a base plate support. For example, each base support can be formed by a member having dimensions of 2″×4″×¼″. Each base support can be 4″ long.

In some implementations, multiple lifting eyes (e.g., four lifting eyes —142a, b, c, d) are attached on the first surface 104 (e.g., the top surface) of the four corners of the base plate 102. Each lifting eye defines a through hole through which a cable can be passed to form a sling that can be connected to a crane to lift the base plate 102 with the industrial tool. For example, each lifting eye can be formed by a plate that is ⅜″ thick, 4″ tall, 4″ long and defines a lifting eye that is 1½″ in diameter.

FIG. 2 is an example of an industrial valve 200 placed on the assembly 100. As described above with reference to FIG. 1, the four holding attachments 110a, b, c, d are first fixed to the first surface 104 of the base plate 102. In particular, the slots 124a, b, c, d of the first beams of the four holding attachments 110a, b, c, d, respectively, are placed to overlap with the slots 132a, b, c, d, respectively defined by the base plate 102. The exact location of each holding attachment is chosen based on the size of the industrial valve 200. Using fasteners (e.g., nuts and bolts) passed through the slots, the holding attachments are secured to the base plate 102 to define the inner volume 127. Then, the industrial valve 200 is placed in the inner volume 127 between the four holding attachments 110a, b, c, d.

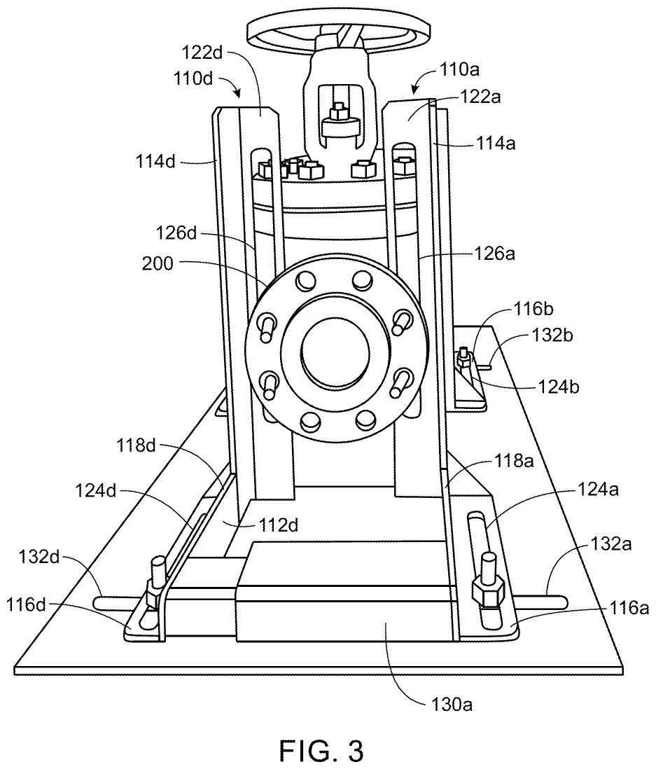

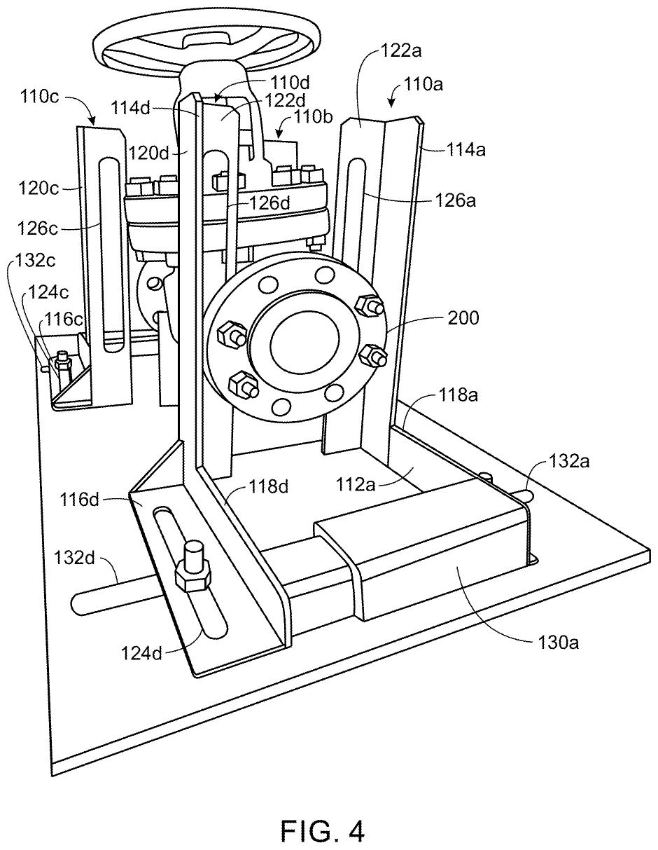

FIG. 3 is an example of the industrial valve 200 fixed to the assembly 100. After the holding attachments are secured to the base plate 102 and the industrial valve 200 is positioned in the inner volume 127, the lengths of the square tubes 130a, b are adjusted. Doing so slides the holding attachments on the base plate 102 either towards or away from each other until the holding attachments (specifically, the second beams 114a, b, c, d) contact the industrial valve 200. Then, using fasteners (e.g., nuts and bolts) passed through the slots 132a, b, c, d, the industrial valve 200 is secured to the holding attachments. FIG. 4 is an example of the industrial valve 200 removably attached to the assembly 100. Specifically, FIG. 4 shows one side of the industrial valve 200 bolted to the second beams of the holding attachments, and the first beams of those holding attachments bolted to the base plate 102. Upon similarly securing the other side of the industrial valve 200 to the holding attachments and securing the holding attachments to the base plate 102, the base plate 102 with the industrial valve 200 can be transported, safely stored or hydrostatically tested.

Thus, particular implementations of the subject matter have been described. Other implementations are within the scope of the following claims.

1. An industrial tool support and transportation assembly comprising:
a base plate having a surface area that is greater than a surface area of an industrial tool to be supported and transported by the assembly, the base plate having a first surface and a second surface opposite the first surface; and
a plurality of holding attachments, each holding attachment comprising a first beam and a second beam attached to each other to form an L-shape, each first beam configured to removably attach to the first surface of the base plate, each second beam configured to extend perpendicularly away from the first surface, each first beam defining a respective slot through which a respective holding attachment is to be removably attached to the base plate, each second beam defining a respective slot through which the industrial tool is to be removably attached to the plurality of holding attachments.

2. The assembly of claim 1, further comprising a plurality of saddle supports, each configured to be removably attached to the first surface, the plurality of saddle supports to cooperate with the plurality of holding attachments to prevent the industrial tool from falling when the industrial tool is disconnected from each second beam.

3. The assembly of claim 1, further comprising a plurality of square tubes, a square tube connected to two holding attachments, wherein a length of the square tube is variable to adjust a distance between the two holding attachments to which the square tube is connected based on a dimension of the industrial tool to be supported by the plurality of holding attachments.

4. The assembly of claim 3, wherein the base plate defines a plurality of slots, each slot formed adjacent to a square tube, each slot defined by the base plate configured to be aligned with the respective slot defined by the first beam to removably attach the industrial tool to the base plate.

5. The assembly of claim 1, further comprising a square tube attached to the second surface of the base plate, wherein a length of the square tube is variable to adjust a distance between ends of the square tube, wherein the ends of the square tube are configured to guide a forklift along the second surface of the base plate.

6. The assembly of claim 1, further comprising a plurality of L-beams, each attached to the second surface of the base plate, the plurality of L-beams configured to support the base plate when the assembly is placed on a floor.

7. The assembly of claim 1, wherein the base plate is a rectangular base plate, wherein the assembly further comprises a plurality of lifting eyes, each lifting eye attached to a respective corner of the base plate, each lifting eye defining a through hole to connect the plurality of lifting eyes to a crane to lift the base plate.

8. The assembly of claim 1, wherein the plurality of holding attachments includes four holding attachments arranged on the first surface in an arrangement within which the industrial tool can be positioned.

9. An industrial tool support and transportation assembly comprising:
a base plate having a first surface and a second surface opposite the first surface, the base plate defining a surface area that is greater than a surface area of an industrial tool to be supported and transported by the assembly; and
four holding attachments, each holding attachment formed in an L-shape, each holding attachment comprising a first beam and a second beam attached to the first beam, each first beam being parallel to and removably attached to the first surface, each second beam being perpendicular to the first surface, each second beam attached to a respective first beam, the four holding attachments spatially arranged on the first surface to define an inner volume in which the industrial tool is to be received; and
two saddle supports positioned in the inner volume and attached to the first surface, the two saddle supports configured to cooperate with the four holding attachments to maintain the industrial tool in an upright position.

10. The assembly of claim 9, wherein each first beam of each holding attachment defines a respective slot through which the respective holding attachment is removably attached to the base plate.

11. The assembly of claim 10, wherein the base plate defines four slots, each slot at least partially overlapping with a respective slot defined by each first beam of each of the four holding attachments, the four slots defined by the base plate and the overlapping respective slots defined by the first beams of the four holding attachments configured to receive respective fasteners to attach the respective holding attachment to the first surface of the base plate.

12. The assembly of claim 9, wherein each second beam of each holding attachment defines a respective slot through which the industrial tool is to be removably attached to the respective holding attachment.

13. The assembly of claim 12, further comprising:
a first square tube connecting a first beam of a first holding attachment to a first beam of a second holding attachment, the first square tube attached to the first surface of the base plate, a length of the first square tube is variable to adjust a distance between the first holding attachment and the second holding attachment; and
a second square tube connecting a first beam of a third holding attachment to a first beam of a fourth holding attachment, the second square tube attached to the first surface of the base plate, a length of the second square tube is variable to adjust a distance between the third holding attachment and the fourth holding attachment.

14. The assembly of claim 9, further comprising a square tube attached to the second surface of the base plate, wherein a length of the square tube is variable to adjust a distance between ends of the square tube, wherein the ends of the square tube are configured to guide a forklift along the second surface of the base plate.

15. The assembly of claim 9, further comprising a plurality of L-beams, each attached to the second surface of the base plate, the plurality of L-beams configured to support the base plate when the assembly is placed on a floor.

16. The assembly of claim 9, wherein the base plate is a rectangular base plate, wherein the assembly further comprises a plurality of lifting eyes, each lifting eye attached to a respective corner of the base plate, each lifting eye defining a through hole to connect the plurality of lifting eyes to a crane to lift the base plate.

17. The assembly of claim 9, wherein the plurality of holding attachments includes four holding attachments arranged on the first surface in an arrangement within which the industrial tool can be positioned.
